(19) United States
(12) Patent Application Publication
(10) Pub. No.: US 2003/0192653 A1
(43) Pub. Date: Oct. 16, 2003

(54) Venetian blind with concealed lift cords

(75) Inventor: Ming Nien, Chang Hua Hsien (TW)

Correspondence Address: BACON & THOMAS, PLLC, 625 SLATERS LANE, FOURTH FLOOR, ALEXANDRIA, VA, 22314

(73) Assignee: Nien Msde Enterprise Co., Ltd., Chang Hua Hsien (TW)

(21) Appl. No.: 10/162,647

(22) Filed: Jun. 6, 2002

(30) Foreign Application Priority Data
Apr. 11, 2002 (TW) 91204732

(51) Int. Cl. E06B 9/30

(52) U.S. Cl. 160/168.1 R

(57) ABSTRACT

A Venetian blind with concealed lift cords is constructed to include a headrail, a bottom rail, slats, two side tracks vertically fixedly provided at two sides of the window and adapted to guide movement of the bottom rail and the slats, and two lift cords vertically extended through the slats in parallel, each lift cord having a respective top end fastened to the headrail and a respective bottom end inserted into the inside of the bottom rail and respectively extended out of the ends of the bottom rail in reversed directions into the inside of the longitudinal sliding grooves of the side tracks and then turned vertically downwards along the longitudinal sliding grooves and fixedly fastened to bottom end of the longitudinal sliding grooves.

### BACKGROUND OF THE INVENTION

1. Field of the Invention

The present invention relates to Venetian blinds and, more specifically, to a Venetian blind with concealed lift cords that keeps the lift cords from sight and from reach of children.

2. Description of the Related Art

A regular Venetian blind is generally comprised of a top rail, a bottom rail, a plurality of slats arranged in parallel between the top rail and the bottom rail, a lift control mechanism for controlling lifting and positioning of the bottom rail to adjust the extending area of the Venetian blind, and a tilting control mechanism for controlling the tiling angle of the slats to regulate the light. The lift control mechanism comprises a lift cord suspended from the top rail at one side for operation by hand to control the elevation of the bottom rail. Because the lift cord is exposed to the outside, it destroys the sense of beauty of the Venetian blind. Further, because a child can easily reach the exposed lift cord, an accident may occur when a child pulling the lift cord for fun.

U.S. Pat. No. 6,044,889 disclosed a Venetian blind designed to eliminate the aforesaid problem. This structure of Venetian blind comprises a headrail, a bottom rail, a set of slats, and two lift cords mounted in the headrail. Each lift cord has one end extended downwards through the slats into the inside of the bottom rail and then extended sideways to the outside of the bottom rail, and the other end fastened to a respective bobbin in the wall. When adjusting the extending area of the blind, directly push the bottom rail upwards or pull it downwards to the desired elevation and then release the hand from the bottom rail for enabling the tension of the lift cords to hold the bottom rail in position.

The aforesaid US patent does not keep the lift cords completely away from sight, i.e., the bottom ends of the lift cords are exposed to the outside. The exposed sections of the lift cords may hook the arm or neck of the person touching the blind accidentally, or may be stretched and damaged by an external moving object.

### SUMMARY OF THE INVENTION

It is the main object of the present invention to provide a Venetian blind with concealed lift cords, which can easily be operated to positively control the elevation of the blind without letting the lift cords exposed to the outside.

It is another object of the present invention to provide a Venetian blind with concealed lift cords, which is safe and durable in use.

To achieve these objects of the present invention, the Venetian blind comprises a headrail fixedly transversely fastened to the window at a top side; a bottom rail extended in transverse direction and spaced below the headrail; a plurality of slats arranged in parallel between the headrail and the bottom rail; two side tracks respectively fixedly fastened to two opposite lateral sides of the window in vertical, the side tracks each having a longitudinal sliding groove facing each other; and two lift cords extended in parallel through the slats, the lift cords each having a first end fastened to the headrail and a second end downwardly inserted through the slats into the inside of the bottom rail and extended transversely out of two distal ends of the bottom rail in reversed directions into the inside of the longitudinal sliding grooves of the side tracks and then downwardly extended along the longitudinal sliding grooves of the side tracks and fixedly fastened to a respective bottom end of the longitudinal sliding groove of the side tracks.

### BRIEF DESCRIPTION OF THE DRAWINGS

FIG. 1 is a schematic drawing of a first embodiment of the present invention, showing the Venetian blind extended out.

FIG. 2 is a sectional view taken along line 2-2 of FIG. 1.

FIG. 3 is a schematic drawing corresponding to FIG. 1, showing the blind received.

FIG. 4 is a sectional view taken along line 4-4 of FIG. 3.

FIG. 5 is a schematic drawing showing a Venetian blind with concealed lift cords constructed according to a second embodiment of the present invention.

FIG. 6 is a schematic drawing showing a Venetian blind with concealed lift cords constructed according to a third embodiment of the present invention.

FIG. 7 is a schematic drawing showing a Venetian blind with concealed lift cords constructed according to a fourth embodiment of the present invention.

FIG. 8 is an exploded view in an enlarged scale of a part of FIG. 7 showing the structure of the tension adjustment mechanism.

FIG. 9 is a sectional view taken along line 9-9 of FIG. 7 showing the engaged status of the tension adjustment mechanism.

FIG. 10 is similar to FIG. 9 but showing the tension adjustment mechanism released.

### DETAILED DESCRIPTION OF THE PREFERRED EMBODIMENT

Referring to FIGS. from 1 through 4, a Venetian blind 10 is shown comprising a headrail 12 fixedly transversely fastened to the top side of the window W, the headrail 12 having two tension springs 14 bilaterally disposed on the inside in the middle, the tension springs 14 each having an inner end fastened to the inside of the headrail 12, a bottom rail 16 extended in transverse direction and spaced below the headrail 12, a number of slats 18 arranged in parallel between the headrail 12 and the bottom rail 16, a first side track 20A, a second side track 20B, a first lift cord 30A, and a second lift cord 30B.

The side tracks 20A;20B are vertically fixedly fastened to the two opposite vertical lateral sides of the window W below the elevation of the headrail 21 and downwardly extended to a position lower than the elevation of the stool of the window W, each comprising a longitudinal sliding groove 22 facing each other. The two distal ends of the bottom rail 16 are respectively inserted into the inside the longitudinal sliding grooves 22 of the tracks 20A;20B. The lift cords 30A;30B are respectively bilaterally inserted through the slats 18, each having respective top and bottom ends respectively inserted into the inside of the headrail 12 and the inside of the bottom rail 16. After inserted into the inside of the headrail 12, the first ends (top ends) of the lift cord 30A;30B are respectively turned inwards toward the mid point of the headrail 12 and then respectively fixedly connected to the outer ends of the tension springs 14. After inserted into the inside of the bottom rail 16, the second end (bottom end) of the first lift cord 30A is turned rightwards out of the right end of the bottom rail 16 into the inside of the longitudinal sliding groove 22 of the second side track 20B and then extended downwards along the longitudinal sliding groove 22 of the second side track 20B and finally fixedly fastened to the bottom end of the longitudinal sliding groove 22 of the second side track 20B. After inserted into the inside of the bottom rail 16, the second end (bottom end) of the second lift cord 30B is turned leftwards out of the left end of the bottom rail 16 into the inside of the longitudinal sliding groove 22 of the first side track 20A and then extended downwards along the longitudinal sliding groove 22 of the first side track 20A and finally fixedly fastened to the bottom end of the longitudinal sliding groove 22 of the first side track 20A.

By means of the aforesaid structure arrangement (the tilting control mechanism of the Venetian blind is of the known art and not within the scope of the claims of the present invention, no further detailed description on the tilting control mechanism is necessary), the tension force of the lift cords 30A;30B hold the bottom rail 16 in position, keeping the Venetian blind 10 in the corresponding extending position. When adjusting the elevation of the blind, the user needs only to directly move the bottom rail 16 with the hand to the desired elevation and then release the hand from the bottom rail 16.

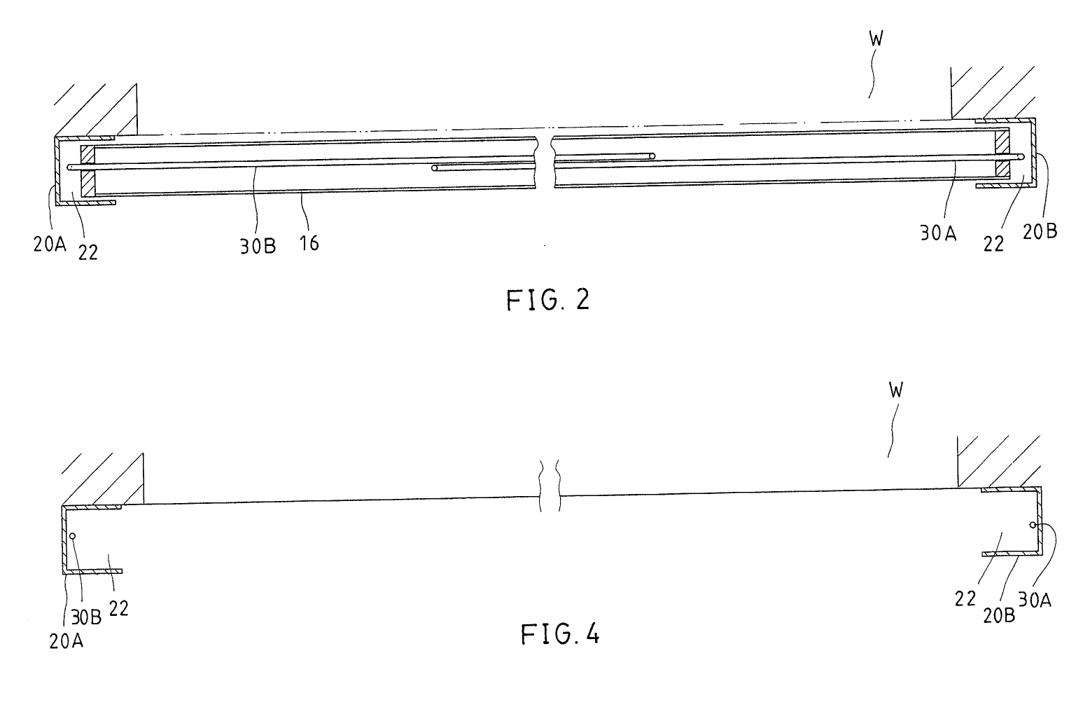

During lifting, the ends of the bottom rail 16 are maintained in the longitudinal sliding grooves 22 of the side tracks 20A;20B (see FIG. 2), preventing oscillation of the blind. Because the bottom rail 16 is confined to the side tracks 20A;20B (the ends of each slat 18 are also respectively inserted into the longitudinal sliding grooves 22 of the side tracks 20A;20B), the blind of the Venetian blind 10 is maintained in vertical and will not swing in the wind.

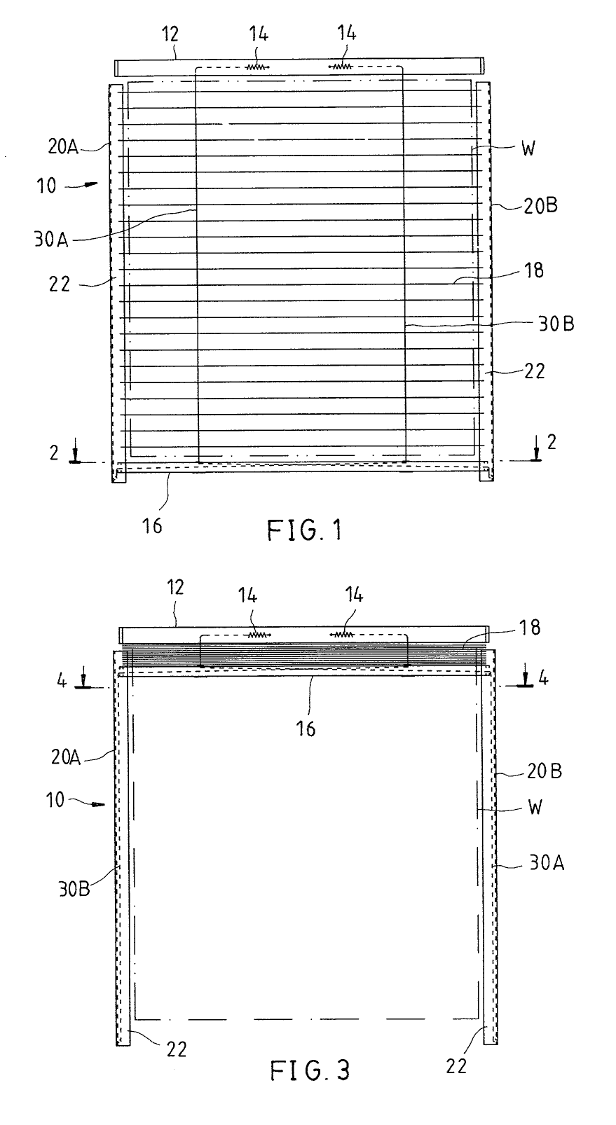

During lifting, the bottom rail 16 can be moved between the upper limit position shown in FIG. 1 where the Venetian blind 10 is fully extended out and the lower limit position shown in FIG. 3 where the Venetian blind 10 is fully received, and positioned in any elevational position between the upper limit position and the lower limit position. When the bottom rail 16 positioned in any elevational position, the second ends (bottom ends) of the lift cords 30A;30B are constantly maintained inside the longitudinal sliding grooves 22 of the side tracks 20A;20B (see FIGS. 3 and 4), i.e., protected within the side tracks 20A;20B. Therefore, the lift cords 30A;30B are kept away from sight and reach of children.

In the aforesaid first embodiment of the present invention, the first ends (top ends) of the lift cords 30A;30B are respectively connected to the tension springs 14 inside the headrail 12, providing a tension force to support the bottom rail 16 and, enabling the bottom rail 16 to be moved up and down along the longitudinal sliding grooves 22 of the side tracks 20A;20B. Alternatively, the tension springs 14 can be provided near the ends of the headrail 12 with the respective outer ends fixedly fastened to the headrail 12 and the respective inner ends respectively fastened to the first ends (top ends) of the lift cords 30A;30B.

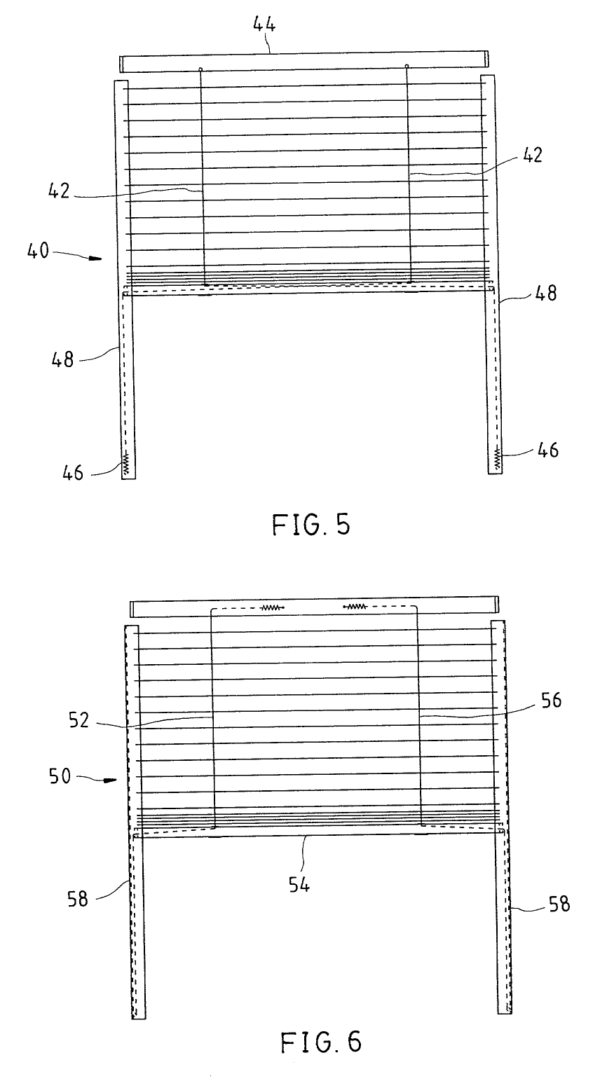

FIG. 5 shows a Venetian blind 40 with concealed lift cords according to a second embodiment of the present invention. According to this embodiment, the top ends of the lift cords 42 are directly fixedly fastened to the headrail 44, and the bottom ends of the lift cords 42 are respectively connected to the respective tension springs 46, which are fixedly provided inside the bottom rail 48. The tension springs 46 may be eliminated if the lift cords are made of elastic material or non-elastic material.

FIG. 6 shows a Venetian blind with concealed lift cords according to a third embodiment of the present invention. According to this embodiment, the bottom ends of the lift cord 52;56 are respectively bilaterally inserted into the bottom rail 54 and then turned sideways in reversed directions and extended out of the two ends of the bottom rail 54 to the inside of the longitudinal sliding grooves of the side tracks 58 and then extended downwards along the longitudinal sliding grooves of the side tracks 58 and fixedly fastened to the bottom ends the longitudinal sliding grooves of the side tracks 58 respectively. According to this arrangement, the lift cords 52;56 are capable of supporting the bottom rail 54 at the desired elevation between the upper limit position and the lower limit position.

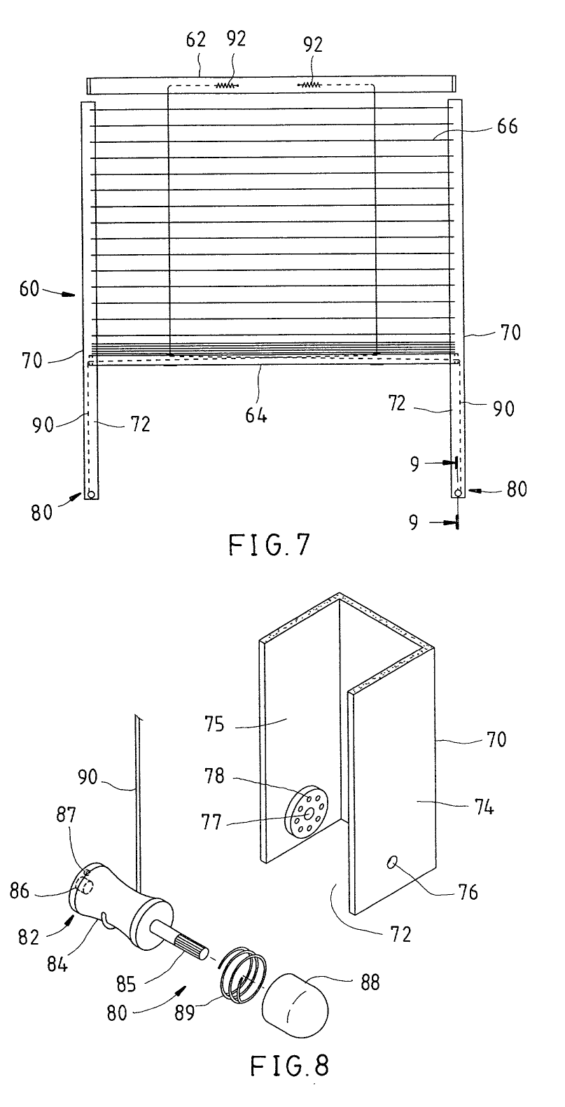

FIG. 7 shows a Venetian blind with concealed lift cords according to a fourth embodiment of the present invention. According to this embodiment, the Venetian blind 60 is comprised of a headrail 62 fixedly fastened to the top side of the window, a bottom rail 64 disposed in parallel to and spaced below the headrail 62, a number of slats 66 arranged in parallel between the headrail 62 and the bottom rail 64, two side tracks 70 vertically fixedly fastened to the two opposite vertical lateral sides of the window, each side track 70 having a longitudinal sliding groove 72, two tension adjustment mechanisms 80 respectively provided at the bottom ends of the longitudinal sliding grooves 72 of the side tracks 70, and two lift cords 90, the lift cords 90 each having a first end respectively fastened to the respective tension springs 92 in the headrail 62 and a bottom end extended downwardly through the slats 66 into the inside of the bottom rail 64 and then extended sideways out of the ends of the bottom rail 64 to the inside of the longitudinal sliding grooves 72 of the side tracks 70 and then extended downwards along the longitudinal sliding grooves 72 of the side tracks 70 and connected to the tension adjustment mechanisms 80 respectively.

Referring to FIGS. from 8 through 10 and FIG. 7 again, each side track 70 comprises a front sidewall 74 and a rear sidewall 75 arranged in parallel, a first pivot hole 76 and a second pivot hole 77 respectively provided in the sidewalls 74;75, and a plurality of locating holes 78 provided in the rear sidewall 75 and equiangularly spaced around the second pivot hole 77. Each tension adjustment mechanism 80 comprises a bobbin 82, a knob 88, and a compression spring 89. The bobbin 82 comprises a body 84, a front round rod 85 axially extended from the center of one end of the body 84, a rear round rod 86 axially extended from the center of the other end of the body 84, and a pin 87 protruded from one end of the body 84 adjacent to the rear round rod 86. The round rods 85;86 are respectively pivotally mounted in the pivot holes 76;77 of the corresponding side track 70. The knob 88 is fastened to the end of the front round rod 85 and disposed outside the corresponding side track 70. The compression spring 89 is mounted on the round rod 85 inside the corresponding side track 70, having one end stopped at the inner surface of the front sidewall 74 of the corresponding side track 70 and the other end stopped against one end of the body 84. The compression spring 89 imparts a pressure to the bobbin 82, forcing the bobbin 82 backwardly away from the front sidewall 74 of the corresponding side track 70 toward the rear sidewall 75. The second end of each lift cord 90 is fixedly fastened to the periphery of the body 84 of the bobbin 82 of the corresponding tension adjustment mechanism 80.

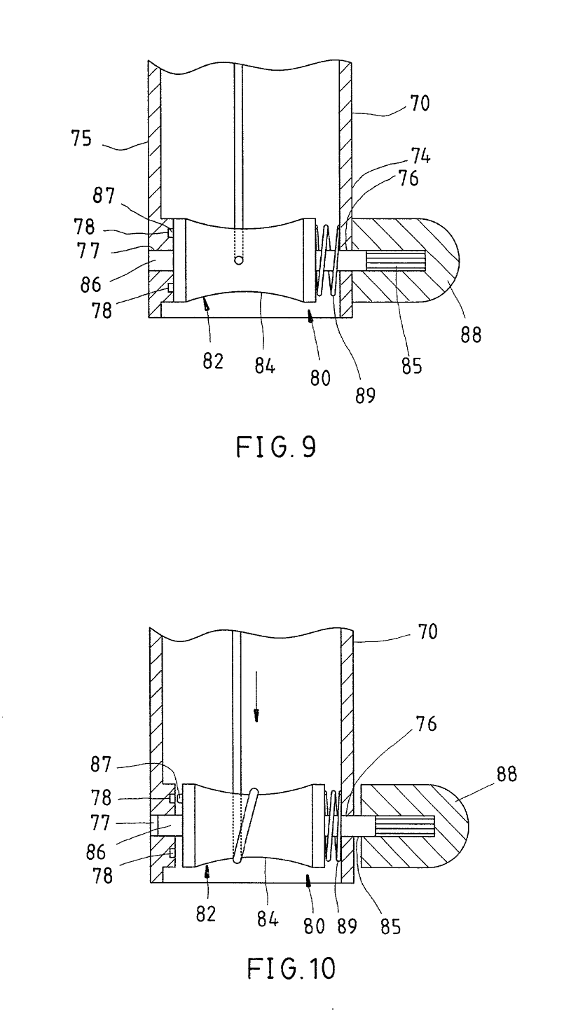

Referring to FIG. 9, normally, the compression spring 89 holds the respective bobbin 82 in the rear end position, keeping the pin 87 engaged into one locating hole 78 of the corresponding side track 70 to stop the bobbin 82 from rotary motion relative to the corresponding side track 70, and therefore the second end of each lift cord 90 is held at the bottom end of the corresponding side track 78 for enabling the tension of the respective lift cord 90 to be maintained at a fixed level to support the bottom rail 64 at the desired elevation. In case the tension springs 92 start to wear due to long uses and the tension force of the lift cords 90 becomes insufficient, the user can pull the knob 88 of each tension adjustment mechanism 80 to disengage the pin 87 of the bobbin 82 of each tension adjustment mechanism 80 from the locating holes 78, and then drive the knob 88 of each tension adjustment mechanism 80 to rotate the respective bobbin 82, causing the respective bobbin 82 to wind up the corresponding lift cord 90 (i.e., to adjust the tension of the corresponding lift cord 90), and then release the hand from the knob 88 for enabling the corresponding compression spring 89 to force the corresponding bobbin 82 backward into engagement with one locating hole 78 again.

What the invention claimed is:

1. A Venetian blind installed in a window and adapted for regulating light, comprising:
a headrail fixedly transversely fastened to said window at a top side;
a bottom rail extended in transverse direction and spaced below said headrail;
a plurality of slats arranged in parallel between said headrail and said bottom rail;
two side tracks respectively fixedly fastened to two opposite lateral sides of said window in vertical, said side tracks each having a longitudinal sliding groove facing each other; and
two lift cords extended in parallel through said slats, said lift cords each having a first end fastened to said headrail and a second end downwardly inserted through said slats into the inside of said bottom rail and extended transversely out of two distal ends of said bottom rail in reversed directions into the inside of the longitudinal sliding grooves of said side tracks and then downwardly extended along the longitudinal sliding grooves of said side tracks and fixedly fastened to a respective bottom end of said longitudinal sliding groove of said side tracks.

2. The Venetian blind as claimed in claim 1, further comprising two tension springs respectively mounted inside said headrail, said tension springs each having one end fixedly fastened to said headrail and an opposite end respectively connected to the first ends of said lift cords to secure said lift cords to said headrail.

3. The Venetian blind as claimed in claim 2, wherein said side tracks each comprise a tension adjustment mechanism disposed in a bottom end of the respective longitudinal sliding groove and connected to the second end of one of said lift cords and adapted for adjusting the tension of the corresponding lift cord.

4. The Venetian blind as claimed in claim 3, wherein said side tracks each comprise a front pivot hole, a rear pivot hole in alignment with said front pivot hole, and a plurality of locating holes equiangularly spaced around said rear pivot hole; the tension adjustment mechanism of each of said side tracks comprises a bobbin fixedly fastened the second end of the corresponding lift cord and adapted for winding up the corresponding lift cord to adjust the tension of the corresponding lift cord, said bobbin comprising a bobbin body, said bobbin body having a front end and a rear end, a front round rod axially extended from the center of the front end of said bobbin body and pivotally mounted in the front pivot hole of the corresponding side track, a rear round rod axially extended from the center of the rear end of said bobbin body and pivotally inserted into the rear pivot hole of the corresponding side track, and a pin protruded from the rear end of said bobbin body and adapted for engaging into one locating hole of the corresponding side track to stop said bobbin from rotary motion relative to the corresponding side track, a knob fastened to an outer end of said front round rod of said bobbin outside the corresponding side track and adapted for moving said bobbin to disengage said pin from the locating holes of the corresponding side track for enabling said bobbins to be rotated to wind up the corresponding lift cord, and a compression spring mounted on said front round rod inside the corresponding side track and stopped between the front end of said bobbin body and an inner surface of the front sidewall of the corresponding side track to force said pin into engagement with one locating hole of the corresponding side track.

5. The Venetian blind as claimed in claim 1, wherein further comprising two tension springs respectively fastened to a bottom end of the longitudinal sliding groove of each of said side tracks, said tension springs each having one end fixedly fastened to the longitudinal sliding groove of one of said side tracks and an opposite end connected to the second end of one of said lift cords.

6. The Venetian blind as claimed in claim 1, said lift cords include a first lift cord disposed at the left side and a second lift cord disposed at the right side; said side tracks include a first side track disposed at the left side and a second side track disposed at the right side; the second end of said first lift cord is extended rightwards along said bottom rail to the outside of a right end of said bottom rail into the inside of the longitudinal sliding groove of said second side track and then fixedly fastened to the bottom end of the longitudinal sliding groove of said second side track; the second end of said second lift cord is extended leftwards along said bottom rail to the outside of a left end of said bottom rail into the inside of the longitudinal sliding groove of said first side track and then fixedly fastened to the bottom end of the longitudinal sliding groove of said first side track.

7. The Venetian blind as claimed in claim 1, wherein said lift cords include a first lift cord disposed at the left side and a second lift cord disposed at the right side; said side tracks include a first side track disposed at the left side and a second side track disposed at the right side; the second end of said first lift cord is extended leftwards to the outside of a left end of said bottom rail into the inside of the longitudinal sliding groove of said first side track and then fixedly fastened to the bottom end of the longitudinal sliding groove of said first side track; the second end of said second lift cord is extended rightwards to the outside of a right end of said bottom rail into the inside of the longitudinal sliding groove of said second side track and then fixedly fastened to the bottom end of the longitudinal sliding groove of said second side track.

8. The Venetian blind as claimed in claim 1, wherein said bottom rail has two distal ends respectively suspended in the longitudinal sliding grooves of said side tracks.
